(19) United States
(12) Patent Application Publication
(10) Pub. No.: US 2026/0058431 A1
(43) Pub. Date: Feb. 26, 2026

(54) LASER APPARATUS AND METHOD OF MANUFACTURING ELECTRONIC DEVICE

(71) Applicants: Inter-University Research Institute Corporation National Institutes of Natural Sciences, Tokyo (JP); Gigaphoton Inc., Oyama-shi (JP)

(72) Inventors: Ryo YASUHARA, Toki city (JP); Yuki TAMARU, Oyama-shi (JP)

(73) Assignees: Inter-University Research Institute Corporation National Institutes of Natural Sciences, Tokyo (JP); Gigaphoton Inc., Oyama-shi (JP)

(21) Appl. No.: 19/258,858

(22) Filed: Jul. 2, 2025

(30) Foreign Application Priority Data
Aug. 23, 2024 (JP) 2024-143476

(51) Int. Cl. H01S 3/08; H01S 3/13

(52) U.S. Cl. CPC H01S 3/08009; H01S 3/1305

(57) ABSTRACT

A laser apparatus includes an optical resonator including an output mirror and a grating, a laser chamber disposed in an optical path of the optical resonator and including a pair of first electrodes configured to apply voltage to a laser gain medium, a power supply, and a first prism that is provided between the laser chamber and the grating and that expands a light beam output from the laser chamber and directs the expanded light beam toward the grating. The first prism includes a pair of second electrodes, and a first electro-optic crystal that changes a direction in which the light beam travels toward the grating when voltage is applied to the second electrodes from the power supply.

### CROSS-REFERENCE TO RELATED APPLICATIONS

The present application claims the benefit of Japanese Patent Application No. 2024-143476, filed on Aug. 23, 2024, the entire contents of which are hereby incorporated by reference.

### BACKGROUND

### 1. Technical Field

The present disclosure relates to a laser apparatus and a method of manufacturing an electronic device.

### 2. Related Art

In recent years, improvement in resolution of semiconductor exposure apparatuses has been desired as semiconductor integrated circuits become more miniaturized and highly integrated. As a result, the wavelength of light output from an exposure light source is caused to become shorter. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

The KrF excimer laser apparatus and the ArF excimer laser apparatus each have a large spectral linewidth of 350 μm to 400 μm in spontaneous oscillation light. Therefore, when a projection lens is formed of a material that transmits ultraviolet rays such as a KrF laser beam and an ArF laser beam, chromatic aberration may occur. As a result, the resolution may decrease. Thus, the spectral linewidth of the laser beam output from the gas laser apparatus needs to be narrowed to the extent that the chromatic aberration can be ignored. Therefore, a line narrowing module (LNM) including a line narrowing element (etalon, grating, or the like) may be provided in a laser resonator of the gas laser apparatus in order to narrow the spectral linewidth. The gas laser apparatus in which the spectral linewidth is narrowed is referred to as a line narrowing gas laser apparatus.

### LIST OF DOCUMENTS

### Patent Documents

Patent Document 1: U.S. Patent Application Publication No. 2005/286598

### SUMMARY

A laser apparatus according to one viewpoint of the present disclosure includes an optical resonator, a laser chamber, a power supply, and a first prism. The optical resonator may include an output mirror and a grating. The laser chamber may be disposed in an optical path of the optical resonator and may include a pair of first electrodes configured to apply voltage to a laser gain medium. The first prism may be provided between the laser chamber and the grating and may expand a light beam output from the laser chamber and direct the expanded light beam toward the grating. The first prism may include a pair of second electrodes, and a first electro-optic crystal that changes a direction in which the light beam travels toward the grating when voltage is applied to the second electrodes from the power supply.

A method of manufacturing an electronic device according to one viewpoint of the present disclosure includes generating a pulse laser beam with a laser apparatus, outputting the pulse laser beam to an exposure apparatus, and exposing a photosensitive substrate to the pulse laser beam in the exposure apparatus to manufacture the electronic device. The laser apparatus includes an optical resonator, a laser chamber, a power supply, and a first prism. The optical resonator may include an output mirror and a grating. The laser chamber may be disposed in an optical path of the optical resonator and may include a pair of first electrodes configured to apply voltage to a laser gain medium. The first prism may be provided between the laser chamber and the grating and may expand a light beam output from the laser chamber and direct the expanded light beam toward the grating. The first prism may include a pair of second electrodes, and a first electro-optic crystal that changes a direction in which the light beam travels toward the grating when voltage is applied to the second electrodes from the power supply.

### BRIEF DESCRIPTION OF THE DRAWINGS

Embodiments of the present disclosure will be described below merely as examples with reference to the accompanying drawings.

FIG. 1 shows a configuration of an exposure system in a comparative example.

FIG. 2 shows the configuration of the exposure system in the comparative example.

FIG. 3 shows a configuration of a laser apparatus according to a first embodiment.

FIG. 4 shows a configuration of a prism.

FIG. 5 is a flowchart of wavelength control in the first embodiment.

FIG. 6 is a flowchart of wavelength control in a second embodiment.

FIG. 7 shows the concept of alternating oscillation of two wavelengths.

FIG. 8 is a flowchart of wavelength control in a third embodiment.

FIG. 9 shows a voltage waveform in which the voltage changes within a pulse.

FIG. 10 shows a configuration of a laser apparatus according to a fourth embodiment.

### DESCRIPTION OF EMBODIMENTS

### <Contents>

1. Comparative Example
   1.1 Exposure System
   1.2 Exposure Apparatus 200
   1.3 Laser Apparatus 100
      1.3.1 Configuration
      1.3.2 Operation
   1.4 Line narrowing Module 14
2. Problem of Comparative Example
3. Laser Apparatus 100a in which Prism 43a Includes Electro-optic Crystal
   3.1 Configuration
   3.2 Operation
   3.3 Effects
4. Laser Apparatus 100a that Performs Alternating Oscillation of Two Wavelengths
   4.1 Operation
   4.2 Effects
5. Laser Apparatus 100a that Changes Voltage V Applied to Electrodes 40a within Pulse
   5.1 Operation
   5.2 Effects
6. Laser Apparatus 100c in which Each of Prisms 41c, 42c, 43a Includes Electro-optic Crystal
   6.1 Configuration and Operation
   6.2 Effects
7. Other

Hereinafter, embodiments of the present disclosure will be described in detail with reference to the drawings. The embodiments described below show some examples of the present disclosure and do not limit the contents of the present disclosure. All configurations and operations described in the embodiments are not necessarily essential as configurations and operations of the present disclosure. The same components are denoted by the same reference characters, and overlapping description thereof is omitted.

### 1. Comparative Example

### 1.1 Exposure System

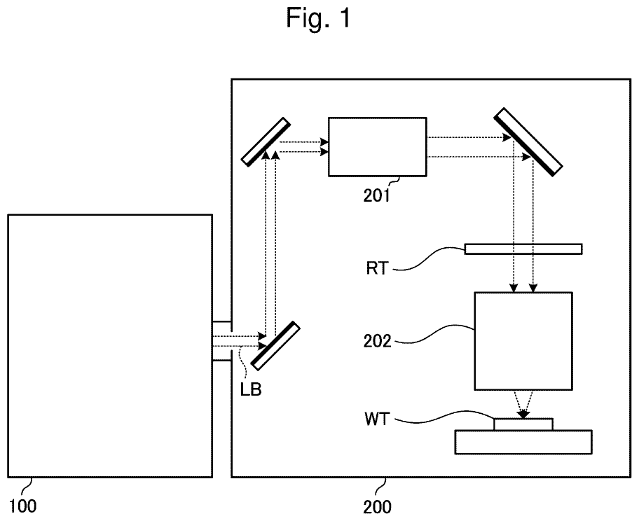

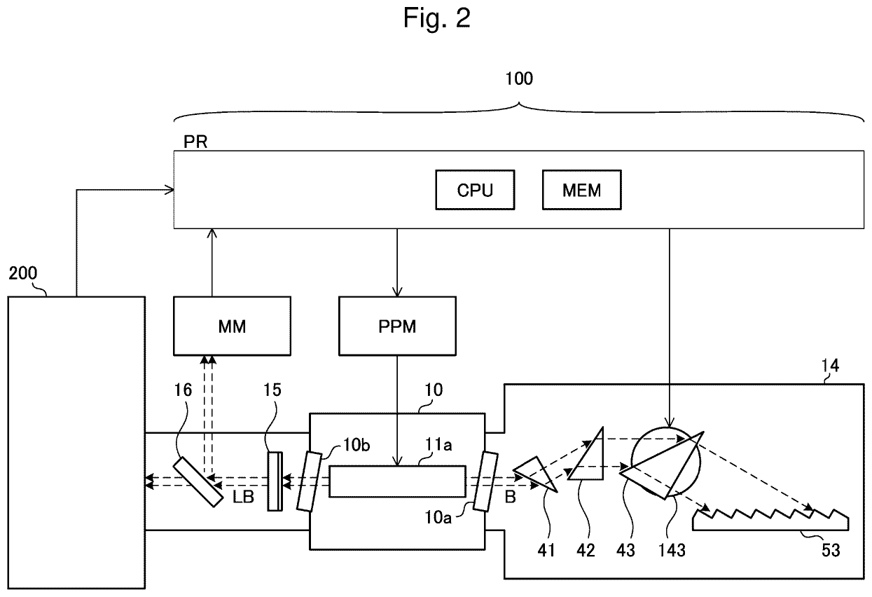

FIG. 1 and FIG. 2 show the configuration of an exposure system in a comparative example. The comparative example of the present disclosure is a form recognized by the applicant as known only by the applicant and is not a publicly known example admitted by the applicant.

The exposure system includes a laser apparatus 100 and an exposure apparatus 200. In FIG. 1, the laser apparatus 100 is shown in a simplified manner. In FIG. 2, the exposure apparatus 200 is shown in a simplified manner. The laser apparatus 100 is configured to output a pulse laser beam LB toward the exposure apparatus 200.

### 1.2 Exposure Apparatus 200

As shown in FIG. 1, the exposure apparatus 200 includes an illumination optical system 201 and a projection optical system 202. The illumination optical system 201 illuminates a reticle pattern of a reticle (not shown) disposed on a reticle stage RT by the pulse laser beam LB entering from the laser apparatus 100. The projection optical system 202 performs reduction projection of the pulse laser beam LB transmitted through the reticle and forms an image on a workpiece (not shown) disposed on a workpiece table WT. The workpiece is a photosensitive substrate such as a semiconductor wafer on which photoresist has been applied.

The exposure apparatus 200 synchronously moves the reticle stage RT and the workpiece table WT in a parallel manner. As a result, the workpiece is exposed to the pulse laser beam LB reflecting the reticle pattern. An electronic device can be manufactured by undergoing a plurality of processes after the reticle pattern is transferred onto the semiconductor wafer by an exposure process as described above.

### 1.3 Laser Apparatus 100

### 1.3.1 Configuration

As shown in FIG. 2, the laser apparatus 100 includes a laser chamber 10, a line narrowing module 14, an output mirror 15, a pulse power module PPM, a monitor module MM, and a processor PR. The output mirror 15 and a grating 53 included in the line narrowing module 14 constitute an optical resonator.

The laser chamber 10 is arranged on an optical path of the optical resonator. Windows 10a, 10b are provided in the laser chamber 10. The laser chamber 10 is configured to contain laser gas including components of a laser gain medium and includes an electrode 11a that applies voltage to the laser gain medium and an electrode (not shown) paired therewith. The laser gain medium is ArF, KrF, or the like. The electrode 11a and the electrode paired therewith correspond to first electrodes in the present disclosure.

The pulse power module PPM includes a switch (not shown) and is connected to a charger (not shown).

The line narrowing module 14 includes prisms 41 to 43 and the grating 53. Details of the line narrowing module 14 will be described later.

The output mirror 15 is formed of a partial reflection mirror. In order to adjust the spectral linewidth and the spectral waveform of the pulse laser beam LB output from the output mirror 15, a spectrum adjusting mechanism including a plurality of cylindrical lenses (not shown) may be arranged.

A beam splitter 16 that transmits a part of the pulse laser beam LB with a high transmittance and reflects another part thereof is disposed in the optical path of the pulse laser beam LB. A monitor module MM is disposed in the optical path of the pulse laser beam LB reflected by the beam splitter 16. The monitor module MM is configured to be able to measure a wavelength, a spectral linewidth, and a spectral waveform of the pulse laser beam LB. Here, the wavelength is the center wavelength.

The processor PR is a processing apparatus including a memory MEM in which a control program is stored, and a central processing unit (CPU) that executes the control program. The processor PR is specifically configured or programmed to execute various processes included in the present disclosure.

### 1.3.2 Operation

The processor PR acquires data on a target value of the wavelength from the exposure apparatus 200. The processor PR transmits an initial setting signal to the line narrowing module 14 based on the target value of the wavelength. After the output of the pulse laser beam LB is started, the processor PR receives a measured value of the wavelength from the monitor module MM and transmits a feedback control signal to the line narrowing module 14 based on the target value of the wavelength and the measured value of the wavelength.

The processor PR receives a trigger signal from the exposure apparatus 200. The processor PR transmits an oscillating trigger signal based on the trigger signal to a switch of the pulse power module PPM. The switch is turned on when the oscillating trigger signal from the processor PR is received. The pulse power module PPM generates pulsed high voltage from the electric energy held in the charger when the switch is turned on. The pulse power module PPM applies this high voltage to the electrode 11a.

When high voltage is applied to the electrode 11a, discharging occurs between the electrode 11a and the electrode paired therewith. The laser gas in the laser chamber 10 is excited by the energy of the discharge and shifts to a high energy level. When the excited laser gas shifts to a low energy level thereafter, light having a wavelength corresponding to the difference between the energy levels is output.

The light generated in the laser chamber 10 is output to the outside of the laser chamber 10 through the windows 10a, 10b. The light output from the window 10a enters the line narrowing module 14 as a light beam B. Among the light that has entered the line narrowing module 14, the light having a wavelength near a desired wavelength is turned back by the line narrowing module 14 and is returned to the laser chamber 10.

The output mirror 15 transmits and outputs a part of the light output from the window 10b and reflects another part back to the laser chamber 10.

In this way, the light output from the laser chamber 10 reciprocates between the line narrowing module 14 and the output mirror 15. The light is amplified each time the light passes through a discharge space between the electrode 11a and the electrode paired therewith. The light that has been laser-oscillated and narrowed in band in this way is output from the output mirror 15 as the pulse laser beam LB and enters the exposure apparatus 200.

### 1.4 Line Narrowing Module 14

The prisms 41 to 43 are arranged in the optical path of the light beam B output from the window 10a in the order from the smallest of those numbers. The prism 43 is rotatable about an axis perpendicular to the plane of paper of FIG. 2 by a rotation stage 143 including a stepping motor or a piezoelectric element. The grating 53 is arranged in the optical path of the light beam B transmitted through the prisms 41 to 43.

The beam width of the light beam B output from the window 10a is expanded in a plane parallel to the plane of paper of FIG. 2 by the prisms 41 to 43. The light beam B transmitted through the prisms 41 to 43 enters the grating 53.

The light beam B that has entered the grating 53 is reflected by a plurality of grooves of the grating 53 and is diffracted in a direction corresponding to the wavelength of the light. The grating 53 is disposed in Littrow arrangement such that the incident angle of the light beam B that has entered the grating 53 from the prisms 41 to 43 coincides with the diffracting angle of diffracted light having a desired wavelength.

The prisms 41 to 43 reduce the beam width of the light beam B returned from the grating 53 within the plane parallel to the plane of paper of FIG. 2 and return the light beam B to the inside of the laser chamber 10 through the window 10a.

The processor PR controls the rotation stage 143 via a driver (not shown). The incident angle of the light beam B that enters the grating 53 changes and the wavelength selected by the line narrowing module 14 changes depending on a change in the posture of the prism 43 in accordance with the rotation angle of the rotation stage 143.

### 2. Problem of Comparative Example

The control of the wavelength by mechanical driving such as the rotation of the prism 43 is affected by inertia, and therefore it may be difficult to improve the response speed. For example, when the target wavelength changes for each pulse, it may be difficult to accurately control the wavelength. Embodiments described below relate to improving the response speed of wavelength control by enabling the wavelength to be changed with high accuracy at high speed.

### 3. Laser Apparatus 100a in which Prism 43a Includes Electro-optic Crystal

### 3.1. Configuration

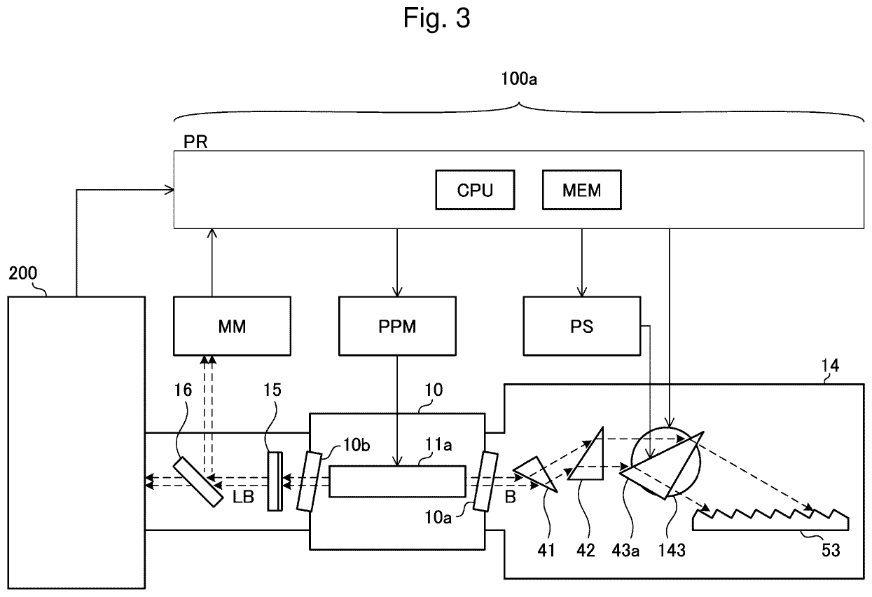

FIG. 3 shows a configuration of a laser apparatus 100a according to a first embodiment. The laser apparatus 100a includes a prism 43a instead of the prism 43 shown in FIG. 2 and further includes a power supply PS. The prism 43a is equivalent to a first prism in the present disclosure.

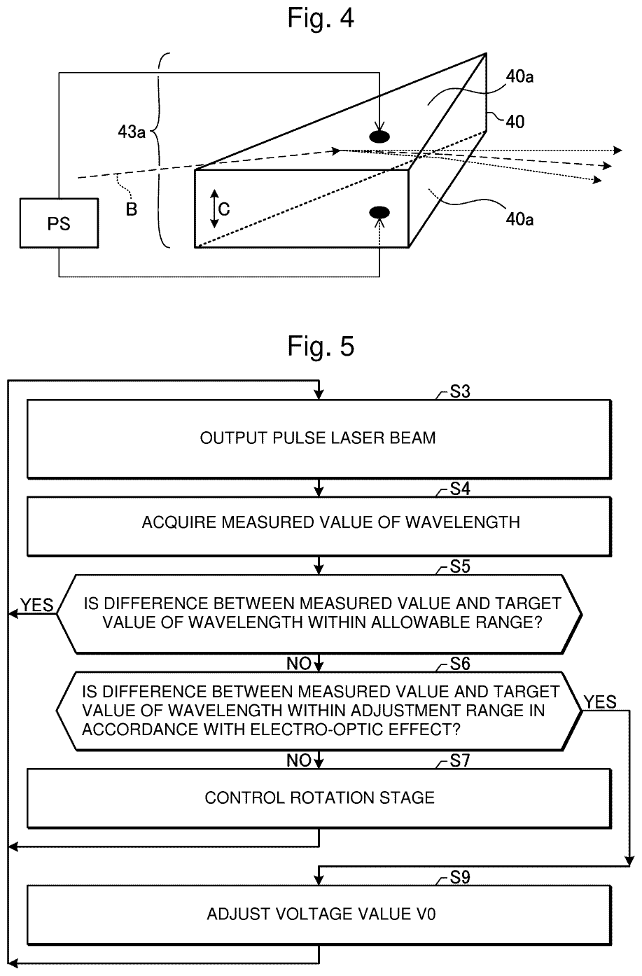

FIG. 4 shows a configuration of the prism 43a. The prism 43a includes an electro-optic crystal 40 and a pair of electrodes 40a. The power supply PS is connected to the electrodes 40a. The electro-optic crystal 40 is equivalent to a first electro-optic crystal in the present disclosure, and the electrodes 40a are equivalent to second electrodes in the present disclosure.

In the electro-optic crystal 40, it is preferable that the internal transmittance at the wavelength of the light beam B be 90%/mm or more and that the maximum value of the components of the electro-optic coefficient tensor at the wavelength of the light beam B be 0.2 pm/V or more. The wavelength of the light beam B is 183 nm or more and 300 nm or less, for example. The electro-optic crystal 40 is LB4 (Li₂B₄O₇, lithium tetraborate) or CLBO (CsLiB₆O₁₀, cesium lithium borate), for example. According to measurement using the Senarmont method by the inventors, an electro-optic coefficient r_{c} of LB4 in the wavelength of 193 nm is 0.3 pm/V, and the electro-optic coefficient r₆₃ of CLBO is 2.1 pm/V.

The electro-optic crystal 40 has a triangular column shape. The c-axis of the electro-optic crystal 40 is indicated by a character C in FIG. 4. The transmission direction of the light beam B is a direction perpendicular to the c-axis. The term “perpendicular” as used herein is not limited to a case of being completely vertical and includes a case where there is a deviation within 5°. The electrodes 40a are disposed on two surfaces of the electro-optic crystal 40 facing each other in the c-axis direction, that is, on two bottom surfaces of a triangular column facing each other so as to apply voltage in a manner parallel to the c-axis. Here, the term “parallel” includes a case in which there is a difference in direction within 2°. In order to increase the uniformity of an electric field inside the electro-optic crystal 40, the electrodes 40a are desired to be arranged so as to cover the entirety of the two bottom surfaces of the triangular column facing each other.

When voltage is applied from the power supply PS to the electrodes 40a, the refractive index of the electro-optic crystal 40 changes due to an electro-optic effect, and the direction in which the light beam B travels toward the grating 53 changes.

Referring back to FIG. 3, the prisms 41, 42 provided between the laser chamber 10 and the prism 43a are similar to those in the comparative embodiment. Each of the prisms 41, 42 corresponds to a second prism in the present disclosure and includes a material in which the maximum value of the component of the electro-optic coefficient tensor at the wavelength of the light beam B is smaller than that of the electro-optic crystal 40. The material also has an internal transmittance per unit length at the wavelength of the light beam B that is greater than that of the electro-optic crystal 40. For example, the material may be calcium fluoride (CaF₂) or may be crystal (SiO₂) or synthetic quartz (SiO₂).

Among the prisms 41, 42, 43a provided between the laser chamber 10 and the grating 53, the prism 43a is located closest to the grating 53. The prism 43a is rotatable by the rotation stage 143 as with the prism 43 in the comparative example. Therefore, the control of the wavelength by an electro-optic effect and the control of the wavelength by mechanical driving are achieved by the same prism 43a.

### 3.2 Operation

FIG. 5 is a flowchart of wavelength control in the first embodiment. The processor PR performs coarse adjustment and fine adjustment of the wavelength as follows.

In S3, the processor PR performs processes such as transmitting an oscillating trigger signal based on a trigger signal from the exposure apparatus 200 such that the pulse laser beam LB is output from the laser apparatus 100a. A process in S3 may include the output of one pulse of the pulse laser beam LB, and processes in S4 and thereafter may be performed for each pulse. Alternatively, the process in S3 may include the output of a plurality of pulses of the pulse laser beam LB, and processes in S4 and thereafter may be performed for each of the plurality of pulses.

In S4, the processor PR acquires a measured value of the wavelength of the pulse laser beam LB from the monitor module MM.

In S5, the processor PR determines whether a difference between the measured value and the target value of the wavelength is within an allowable range. When the difference is within the allowable range (S5: YES), the processor PR returns the process to S3. When the difference is not within the allowable range (S5: NO), the processor PR causes the process to proceed to S6.

In S6, the processor PR determines whether a difference between the measured value and the target value of the wavelength is within an adjustment range in accordance with an electro-optic effect. When the difference is within the adjustment range in accordance with an electro-optic effect (S6: YES), the processor PR causes the process to proceed to S9. When the difference is not within the adjustment range in accordance with an electro-optic effect (S6: NO), the processor PR causes the process to proceed to S7.

In S7, the processor PR adjusts the attitude of the prism 43a by controlling the rotation stage 143 such that the difference between the measured value and the target value of the wavelength approaches zero. The processor PR then returns the process to S3.

In S9, the processor PR adjusts a voltage value V0 of the voltage applied from the power supply PS to the electrodes 40a such that the difference between the measured value and the target value of the wavelength approaches zero. The processor PR then returns the process to S3.

As described above, when the difference between the measured value and the target value of the wavelength is not within the adjustment range in accordance with the electro-optic effect, the coarse adjustment of the wavelength is performed in S7. When the difference is within the adjustment range, the fine adjustment of the wavelength is performed in S9.

### 3.3 Effects

According to the first embodiment, the laser apparatus 100a includes the optical resonator including the output mirror 15 and the grating 53, the laser chamber 10, the power supply PS, and the prism 43a. The laser chamber 10 includes the electrode 11a that applies voltage to the laser gain medium and the electrode paired therewith and is disposed in the optical path of the optical resonator. The prism 43a is provided between the laser chamber 10 and the grating 53, expands the light beam B output from the laser chamber 10, and directs the expanded light beam B toward the grating 53. The prism 43a includes the pair of electrodes 40a and the electro-optic crystal 40 that changes the direction in which the light beam B travels toward the grating 53 when voltage is applied to the electrodes 40a from the power supply PS.

According to the above, the change in the traveling direction from the prism 43a toward the grating 53 is achieved not only by the mechanical driving but also by the application of the voltage, and hence a wavelength-controlled high-speed response can be achieved. Instead of adding an electro-optic element different from the prism, the electro-optic crystal 40 is used as the material of the prism 43a. Therefore, an increase in the number of optical components and an increase in installation space can be suppressed.

According to the first embodiment, the laser apparatus 100a includes the prisms 41, 42 provided between the laser chamber 10 and the prism 43a. The prisms 41, 42 include a material in which the maximum value of the component of the electro-optic coefficient tensor at the wavelength of the light beam B is smaller than that of the electro-optic crystal 40.

According to the above, the material of the prisms 41, 42 may have a small electro-optic coefficient, and hence a decrease in the degree of freedom of material selection can be suppressed. Instead of the prisms 41, 42 disposed between the laser chamber 10 and the prism 43a, the prism 43a is configured with the electro-optic crystal 40. As a result, the change in the wavelength due to the change in the traveling direction toward the grating 53 can be efficiently achieved.

According to the first embodiment, the material included in the prisms 41, 42 has an internal transmittance per unit length at the wavelength of the light beam B that is greater than that of the electro-optic crystal 40.

According to the above, the loss of energy of the light beam B in the prisms 41, 42 can be suppressed.

According to the first embodiment, the prism 43a is located closest to the grating 53 among the plurality of prisms provided between the laser chamber 10 and the grating 53 and including the prism 43a and the prisms 41, 42.

According to the above, a change in the wavelength due to a change in the traveling direction toward the grating 53 can be efficiently achieved. The light beam B expanded by the prisms 41, 42 enters the prism 43a, and the energy-density of the light beam B in the prism 43a is small. Therefore, the deterioration of the electro-optic crystal 40 can be suppressed.

According to the first embodiment, the laser apparatus 100a includes the rotation stage 143 configured to rotate the prism 43a.

According to the above, the prism 43a having a smaller distance to the grating 53 than the prisms 41, 42 causes both a change in the traveling direction due to the electro-optic effect and a change in the traveling direction due to the rotation, and hence a change in the wavelength due to the change in the traveling direction can be efficiently achieved.

According to the first embodiment, the internal transmittance is 90%/mm or more and the maximum value of the component of the electro-optic coefficient tensor is 0.2 pm/V or more in the electro-optic crystal 40 at a wavelength of the light beam B.

According to the above, the loss of energy of the light beam B in the prism 43a can be suppressed and a sufficient electro-optic effect can be obtained.

According to the first embodiment, the electro-optic crystal 40 is either LB4 or CLBO.

According to the above, a sufficient internal transmittance and a sufficient electro-optic effect can be obtained with use of a commercially available material.

According to the first embodiment, the electrodes 40a are arranged so as to apply voltage in a manner parallel to the c-axis of the electro-optic crystal 40.

According to the above, the change in the refractive index due to the electro-optic effect can be sufficiently exhibited.

According to the first embodiment, the electro-optic crystal 40 has a polygonal column shape, and the electrodes 40a are disposed so as to cover the entirety of the two bottom surfaces of the polygonal column facing each other.

According to the above, the electric field distribution inside the electro-optic crystal 40 can be made uniform.

According to the first embodiment, the laser apparatus 100a includes the monitor module MM configured to measure the wavelength of the pulse laser beam LB output after passing through the output mirror 15, and the processor PR configured to control the voltage applied to the electrodes 40a based on the measurement result from the monitor module MM.

According to the above, the wavelength of the pulse laser beam LB can be accurately controlled by the feedback control based on the measurement result.

According to the first embodiment, the laser apparatus 100a includes the rotation stage 143 configured to rotate the prism 43a. The processor PR performs the coarse adjustment of the wavelength and the fine adjustment of the wavelength. The coarse adjustment controls the attitude of the prism 43a based on the measurement result, and the fine adjustment controls the voltage applied to the electrodes 40a based on the measurement result.

According to the above, a high adjustment accuracy can be secured by controlling the voltage applied to the electrodes 40a, and a sufficient adjustment range can be secured by controlling the attitude of the prism 43a.

In the first embodiment, a case in which each of the prisms 41, 42 is not rotatable has been described, but the present disclosure is not limited thereto. For example, the prism 43a may be rotatable by the rotation stage 143 including the stepping motor, and one or each of the prisms 41, 42 may be rotatable by a rotation stage (not shown) including a piezoelectric element. In this case, coarse adjustment can be performed with use of the rotation stage 143 including the stepping motor, fine adjustment can be performed with use of the rotation stage including the piezoelectric element, and adjustment that is even finer can be performed with use of the electro-optic effect.

The number of the prisms is not limited to three and may be two or four or more, for example.

Other features of the first embodiment are similar to those of the comparative embodiment.

### 4. Laser Apparatus 100a that Performs Alternating Oscillation of Two Wavelengths

### 4.1 Operation

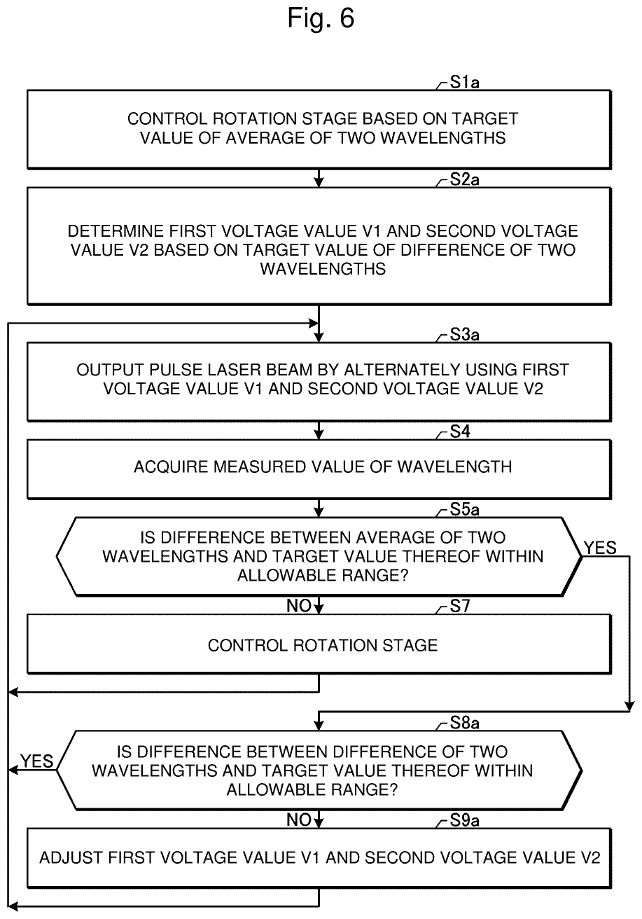

FIG. 6 is a flowchart of wavelength control in a second embodiment. The configuration of the laser apparatus 100a in the second embodiment is similar to that in the first embodiment. The processor PR performs wavelength control in alternating oscillation of two wavelengths as below.

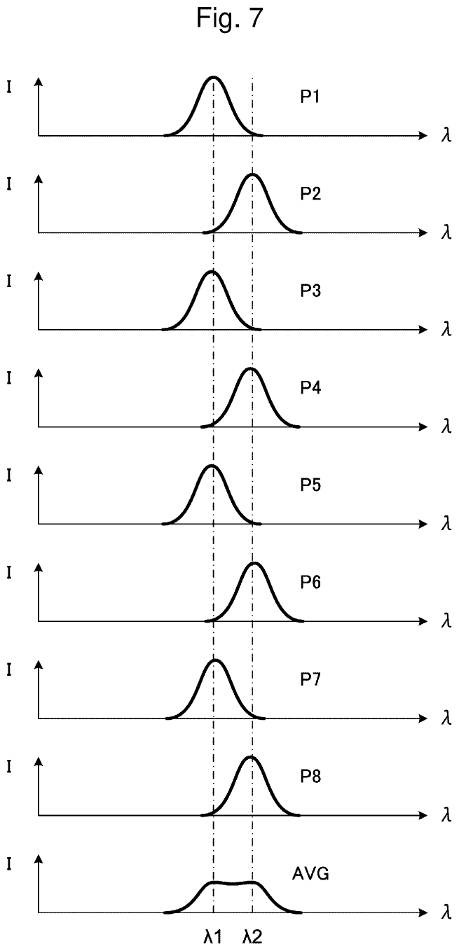

FIG. 7 shows the concept of the alternating oscillation of two wavelengths. In each graph included in FIG. 7, the horizontal axis represents a wavelength λ, and the vertical axis represents a light intensity I. FIG. 7 shows spectral waveforms of pulses P1 to P8 included in the pulse laser beam LB and an average spectral waveform AVG of the pulses P1 to P8. The pulses P1 to P8 are output in the stated order at a predetermined repetition frequency. The pulses P1, P3, P5, P7 have a wavelength λ1, and the pulses P2, P4, P6, P8 have a wavelength λ2. By outputting the pulse laser beam LB while switching the wavelengths as with the pulses P1 to P8, the spectral linewidth of the average spectral waveform AVG can be increased, the depth of focus can be substantially increased, and the processing accuracy of a photoresist having a large film thickness, for example, can be improved. In the second embodiment, the power supply PS is controlled such that the voltage applied to the electrodes 40a periodically changes to a plurality of voltage values different from each other for each of the plurality of pulses in order to perform switching of the waveform for each pulse as above with high precision.

Before starting the description of the flowchart of FIG. 6, the processor PR receives a target value of an average of two wavelengths and a target value of a difference of two wavelengths from the exposure apparatus 200. Alternatively, the processor PR receives a target value of two wavelengths from the exposure apparatus 200 and calculates a target value of the average of two wavelengths and a target value of the difference of two wavelengths.

In S1a of FIG. 6, the processor PR controls the rotation stage 143 based on the target value of the average of two wavelengths.

In S2a, the processor PR determines first voltage value V1 and second voltage value V2 to be applied to the electrodes 40a of the prism 43a based on the target value of the difference of two wavelengths.

In S3a, the processor PR controls the power supply PS such that the voltage having the first voltage value V1 and the voltage having the second voltage value V2 are alternately applied to the electrodes 40a of the prism 43a, and performs processes such as transmitting an oscillation trigger signal based on a trigger signal from the exposure apparatus 200 such that the pulse laser beam LB is output from the laser apparatus 100a.

In S4, the processor PR acquires measured values of the wavelengths of the pulse laser beam LB from the monitor module MM. This process is similar to that of the first embodiment. The processor PR calculates the average of two wavelengths and the difference of two wavelengths from the measured values of the wavelengths.

In S5a, the processor PR determines whether the difference between the average of two wavelengths and the target value thereof is within an allowable range. When the difference is within the allowable range (S5a: YES), the processor PR causes the process to proceed to S8a. When the difference is not within the allowable range (S5a: NO), the processor PR causes the process to proceed to S7.

In S7, the processor PR adjusts the attitude of the prism 43a by controlling the rotation stage 143 such that the difference between the average of two wavelengths and the target value thereof approaches zero. Then, the processor PR returns the process to S3a. Alternatively, the process may be caused to proceed to S8a.

In S8a, the processor PR determines whether the difference between the difference of two wavelengths and the target value thereof is within an allowable range. When the difference is within the allowable range (S8a: YES), the processor PR returns the process to S3a. When the difference is not within the allowable range (S8a: NO), the processor PR causes the process to proceed to S9a.

In S9a, the processor PR adjusts the first voltage value V1 and the second voltage value V2 such that the difference between the difference of two wavelengths and the target value thereof approaches zero. Then, the processor PR returns the process to S3a.

As described above, in the alternating oscillation of two wavelengths, the attitude of the prism 43a is adjusted in S7 based on the average of two wavelengths, and the first voltage value V1 and the second voltage value V2 are adjusted in S9a based on the difference of two wavelengths.

### 4.2 Effects

According to the second embodiment, the laser apparatus 100a includes the processor PR configured to control the power supply PS such that the voltage applied to the electrodes 40a periodically changes to a plurality of voltage values different from each other for each of the plurality of pulses.

According to the above, even when the wavelength is switched for each pulse, the wavelength can be switched accurately by changing the voltage applied to the electrodes 40a.

According to the second embodiment, the laser apparatus 100a includes the monitor module MM configured to measure the wavelength of the pulse laser beam LB output after passing through the output mirror 15. The processor PR controls the power supply PS such that the voltage applied to the electrodes 40a alternately changes between the first voltage value V1 and the second voltage value V2 different from each other. The processor PR adjusts the first voltage value V1 and the second voltage value V2 based on the wavelength difference of the pulse laser beam LB when the voltage having the first voltage value V1 and the voltage having the second voltage value V2 are alternately applied to the electrodes 40a.

According to the above, it becomes possible to output the pulse laser beam LB while switching the wavelength at high speed by controlling the first voltage value V1 and the second voltage value V2 such that the difference in the measured wavelength approaches a target wavelength difference.

According to the second embodiment, the laser apparatus 100a includes the rotation stage 143 configured to rotate the prism 43a. The processor PR controls the rotation stage 143 based on the average wavelength of the pulse laser beam LB when the voltage having the first voltage value V1 and the voltage having the second voltage value V2 are alternately applied to the electrodes 40a.

According to the above, even when the pulse laser beam LB is output while the wavelength is switched, the rotation stage 143 only needs to be controlled based on the average wavelength, and hence the necessity of moving the rotation stage 143 at high speed can be reduced.

In the second embodiment, a case in which the laser oscillation of one pulse with the wavelength λ1 and the laser oscillation of one pulse with the wavelength 22 are repeated has been described, but the present disclosure is not limited thereto. For example, a plurality of pulses of laser oscillation with the wavelength λ1 and a plurality of pulses of laser oscillation with the wavelength λ2 may be repeated. Three or more voltage values may be used so as to periodically change to a wavelength of three or more wavelengths.

### 5. Laser Apparatus 100a that Changes Voltage V Applied to Electrodes 40a within Pulse

### 5.1 Operation

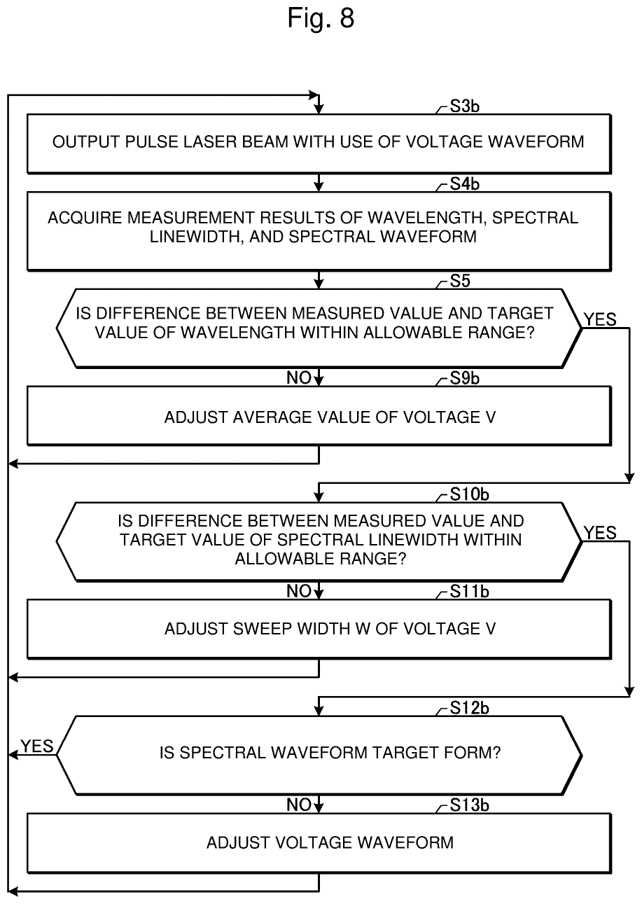

FIG. 8 is a flowchart of wavelength control in a third embodiment. The configuration of the laser apparatus 100a in the third embodiment is similar to that in the first embodiment. The processor PR performs wavelength control that changes voltage V within a pulse as described below.

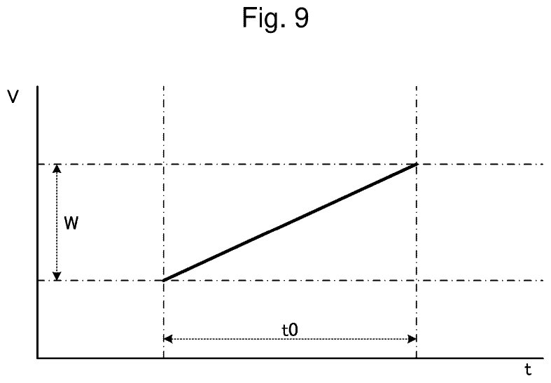

FIG. 9 shows a voltage waveform in which the voltage V changes within a pulse. In FIG. 9, the horizontal axis represents time t, and the vertical axis represents voltage V. The pulse duration of one pulse included in the pulse laser beam LB is defined as to. By controlling the power supply PS such that the voltage V applied to the electrodes 40a changes within the period of the pulse duration to, the spectral linewidth of one pulse can be increased. The difference between the maximum value and the minimum value of the voltage V within the period of the pulse duration to is defined as a sweep width W.

In S3b of FIG. 8, the processor PR controls the power supply PS such that the voltage V changes within the period of the pulse duration to of one pulse with use of the voltage waveform and performs processes such as transmitting an oscillation trigger signal based on a trigger signal from the exposure apparatus 200 such that the pulse laser beam LB is output from the laser apparatus 100a.

In S4b, the processor PR acquires measurement results of the wavelength, the spectral linewidth, and the spectral waveform of the pulse laser beam LB from the monitor module MM.

In S5, the processor PR determines whether a difference between the measured value and the target value of the wavelength is within an allowable range. This process is similar to that of the first embodiment. When the difference is within the allowable range (S5: YES), the processor PR causes the process to proceed to S10b. When the difference is not within the allowable range (S5: NO), the processor PR causes the process to proceed to S9b.

In S9b, the processor PR adjusts the average value of the voltage V in the voltage waveform such that the difference between the measured value and the target value of the wavelength approaches zero. After S9b, the processor PR returns the process to S3b. Alternatively, the process may be caused to proceed to S10b.

In S10b, the processor PR determines whether a difference between the measured value and the target value of the spectral linewidth is within an allowable range. When the difference is within the allowable range (S10b: YES), the processor PR causes the process to proceed to S12b. When the difference is not within the allowable range (S10b: NO), the processor PR causes the process to proceed to S11b.

In S11b, the processor PR adjusts the sweep width W of the voltage V such that the difference between the measured value and the target value of the spectral linewidth approaches zero. After S11b, the processor PR returns the process to S3b. Alternatively, the process may be caused to proceed to S12b.

In S12b, the processor PR determines whether the measured spectral waveform is a target form. When the spectral waveform is the target form (S12b: YES), the processor PR returns the process to S3b. When the spectral waveform is not the target form (S12b: NO), the processor PR causes the process to proceed to S13b.

In S13b, the processor PR adjusts the voltage waveform such that the spectral waveform approaches the target form. After S13b, the processor PR returns the process to S3b.

As described above, the power supply PS can be controlled such that the voltage V changes within the pulse, and not only the wavelength of the pulse laser beam LB but also the spectral linewidth and the spectral waveform can be controlled.

### 5.2 Effects

According to the third embodiment, the laser apparatus 100a includes the processor PR configured to control the power supply PS such that the voltage V applied to the electrodes 40a changes within a period of time equivalent to the pulse duration to of one pulse of the pulse laser beam LB output from the output mirror 15.

According to the above, the spectral linewidth of one pulse can be increased by changing the wavelength within a pulse of one pulse.

According to the third embodiment, the laser apparatus 100a includes the monitor module MM configured to measure the wavelength of the pulse laser beam LB. The processor PR adjusts the average value of the voltage V applied to the electrodes 40a based on the wavelength measured by the monitor module MM.

According to the above, the wavelength of one pulse can be adjusted by changing the average value of the voltage V that changes.

According to the third embodiment, the laser apparatus 100a includes the monitor module MM configured to measure the spectral linewidth of the pulse laser beam LB. The processor PR adjusts the sweep width W of the voltage V applied to the electrodes 40a based on the spectral linewidth.

According to the above, the spectral linewidth can be adjusted by changing the sweep width W.

According to the third embodiment, the laser apparatus 100a includes the monitor module MM configured to measure the spectral waveform of the pulse laser beam LB. The processor PR adjusts the voltage waveform of the voltage V applied to the electrodes 40a based on the measured spectral waveform.

According to the above, the spectral waveform can be adjusted by changing the voltage waveform.

### 6. Laser Apparatus 100c in which Each of Prisms 41c, 42c, 43a Includes Electro-optic Crystal

### 6.1 Configuration and Operation

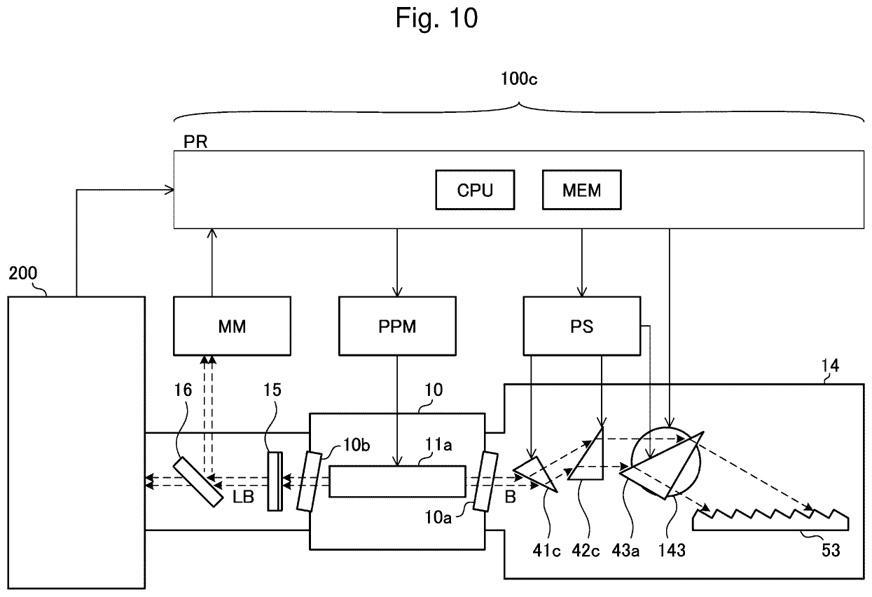

FIG. 10 shows a configuration of a laser apparatus 100c according to a fourth embodiment. The laser apparatus 100c is different from the first embodiment in that the laser apparatus 100c includes prisms 41c, 42c instead of prisms 41, 42 shown in FIG. 3.

One or each of the prisms 41c, 42c corresponds to a third prism in the present disclosure and includes a pair of electrodes and an electro-optic crystal as with the prism 43a described with reference to FIG. 4. The power supply PS is connected to the electrodes. The electro-optic crystal and the electrodes included in the third prism are equivalent to a second electro-optic crystal and a third electrode in the present disclosure, respectively.

The operation of the laser apparatus 100c is similar to that of the first to third embodiments. However, the voltage applied to the electrodes of one or each of the prisms 41c, 42c is also adjusted at the same time as the voltage applied to the electrodes 40a of the prism 43a is adjusted in each of FIG. 5, FIG. 6, and FIG. 8.

### 6.2 Effects

According to the fourth embodiment, the laser apparatus 100c includes the prisms 41c, 42c provided between the laser chamber 10 and the prism 43a. One or each of the prisms 41c, 42c includes the pair of electrodes, and the electro-optic crystal that changes the direction in which the light beam B travels toward the grating 53 when the voltage is applied to the electrodes from the power supply PS.

According to the above, the plurality of prisms 41c, 42c, 43a exhibits the electro-optic effect, and hence the adjustment range of the wavelength by the electro-optic effect can be increased.

Other features of the fourth embodiment are similar to those of the first to third embodiments.

### 7. Other

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the claims should be interpreted as non-limiting terms unless otherwise noted. For example, terms such as “comprise”, “include”, “have”, and “contain” should not be interpreted to be exclusive of components other than those described. Further, indefinite articles “a/an” should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser apparatus comprising:
an optical resonator including an output mirror and a grating;
a laser chamber disposed in an optical path of the optical resonator and including a pair of first electrodes configured to apply voltage to a laser gain medium;
a power supply; and
a first prism that is provided between the laser chamber and the grating and that expands a light beam output from the laser chamber and directs the expanded light beam toward the grating, the first prism including a pair of second electrodes, and a first electro-optic crystal that changes a direction in which the light beam travels toward the grating when voltage is applied to the second electrodes from the power supply.

2. The laser apparatus according to claim 1, further comprising a second prism disposed between the laser chamber and the first prism, wherein the second prism includes a material in which a maximum value of a component of an electro-optic coefficient tensor at a wavelength of the light beam is smaller than a maximum value of a component of an electro-optic coefficient tensor at the wavelength of the light beam in the first electro-optic crystal.

3. The laser apparatus according to claim 2, wherein the material included in the second prism has an internal transmittance per unit length at the wavelength of the light beam that is greater than an internal transmittance per unit length at the wavelength of the light beam in the first electro-optic crystal.

4. The laser apparatus according to claim 2, wherein the first prism is located closest to the grating among a plurality of prisms provided between the laser chamber and the grating and including the first prism and the second prism.

5. The laser apparatus according to claim 2, further comprising a rotation stage configured to rotate the first prism.

6. The laser apparatus according to claim 1, wherein an internal transmittance is 90%/mm or more and a maximum value of a component of an electro-optic coefficient tensor is 0.2 pm/V or more in the first electro-optic crystal at a wavelength of the light beam.

7. The laser apparatus according to claim 1, wherein the first electro-optic crystal is either LB4 or CLBO.

8. The laser apparatus according to claim 1, wherein the second electrodes are arranged so as to apply voltage in a manner parallel to a c-axis of the first electro-optic crystal.

9. The laser apparatus according to claim 1, wherein the first electro-optic crystal has a polygonal column shape, and the second electrodes are disposed so as to cover an entirety of two bottom surfaces of the polygonal column facing each other.

10. The laser apparatus according to claim 1, further comprising:
a monitor module configured to measure a wavelength of a pulse laser beam output after passing through the output mirror; and
a processor configured to control voltage applied to the second electrodes based on a measurement result from the monitor module.

11. The laser apparatus according to claim 10, further comprising a rotation stage configured to rotate the first prism, wherein the processor performs:
coarse adjustment of the wavelength as controlling an attitude of the first prism based on the measurement result; and
fine adjustment of the wavelength as controlling the voltage applied to the second electrodes based on the measurement result.

12. The laser apparatus according to claim 1, further comprising a processor configured to control the power supply such that voltage applied to the second electrodes periodically changes to a plurality of voltage values different from each other for each of a plurality of pulses.

13. The laser apparatus according to claim 12, further comprising a monitor module configured to measure a wavelength of a pulse laser beam output after passing through the output mirror, wherein the processor:
controls the power supply such that voltage applied to the second electrodes alternately changes between a first voltage value and a second voltage value different from each other; and
adjusts the first voltage value and the second voltage value based on a wavelength difference of the pulse laser beam when voltage having the first voltage value and voltage having the second voltage value are alternately applied to the second electrodes.

14. The laser apparatus according to claim 13, further comprising a rotation stage configured to rotate the first prism, wherein the processor controls the rotation stage based on an average wavelength of the pulse laser beam when the voltage having the first voltage value and the voltage having the second voltage value are alternately applied to the second electrodes.

15. The laser apparatus according to claim 1, further comprising a processor configured to control the power supply such that voltage applied to the second electrodes changes within a period of time equivalent to a pulse duration of one pulse of the pulse laser beam output from the output mirror.

16. The laser apparatus according to claim 15, further comprising a monitor module configured to measure a wavelength of the pulse laser beam, wherein the processor adjusts an average value of the voltage applied to the second electrodes based on the wavelength measured by the monitor module.

17. The laser apparatus according to claim 15, further comprising a monitor module configured to measure a spectral linewidth of the pulse laser beam, wherein the processor adjusts a sweep width of the voltage applied to the second electrodes based on the spectral linewidth.

18. The laser apparatus according to claim 15, further comprising a monitor module configured to measure a spectral waveform of the pulse laser beam, wherein the processor adjusts a voltage waveform of the voltage applied to the second electrodes based on the spectral waveform.

19. The laser apparatus according to claim 1, further comprising a third prism provided between the laser chamber and the first prism, wherein the third prism includes a pair of third electrodes, and a second electro-optic crystal that changes a direction in which the light beam travels toward the grating when voltage is applied to the third electrodes from the power supply.

20. A method of manufacturing an electronic device, the method comprising:
generating a pulse laser beam with a laser apparatus including:
an optical resonator including an output mirror and a grating;
a laser chamber disposed in an optical path of the optical resonator and including a pair of first electrodes configured to apply voltage to a laser gain medium;
a power supply; and
a first prism that is provided between the laser chamber and the grating and that expands a light beam output from the laser chamber and directs the expanded light beam toward the grating, the first prism including a pair of second electrodes, and a first electro-optic crystal that changes a direction in which the light beam travels toward the grating when voltage is applied to the second electrodes from the power supply;
outputting the pulse laser beam to an exposure apparatus; and
exposing a photosensitive substrate to the pulse laser beam in the exposure apparatus to manufacture the electronic device.
